(19) United States
(12) Patent Application Publication
(10) Pub. No.: US 2006/0167741 A1
(43) Pub. Date: Jul. 27, 2006

(54) System and method for designing a supply chain

(75) Inventors: Edward David Erickson, San Jose, CA (US); Gia Vy Chung, Pleasanton, CA (US); Anne-Sophie Seigneurbieux, San Jose, CA (US)

Correspondence Address: Trellis Intellectual Property Law Group, PC, 1900 EMBARCADERO ROAD, SUITE 109, PALO ALTO, CA, 94303, US

(73) Assignee: Cisco Technology, Inc., San Jose, CA (US)

(21) Appl. No.: 11/043,742

(22) Filed: Jan. 25, 2005

(51) Int. Cl. G07G 1/00

(52) U.S. Cl. 705/10

(57) ABSTRACT

A system, method and apparatus are provided for designing and evaluating a supply-chain architecture and strategy, and communicating the architecture to concerned parties. The supply chain is designed by combining business strategies and analytical modeling in a well-defined process. Key product and market attributes are combined with defined supply-chain processes and strategies, to identify a preferred supply chain architecture and strategy. Feedback from the concerned parties is collected, and modifications are made iteratively to the supply chain architecture and strategy, based on the collected feedback.

### BACKGROUND OF THE INVENTION

1. Field of Invention

The present invention relates, in general, to the field of supply chain systems. More specifically, the embodiments of the present invention relate to systems and methods for designing a supply chain.

2. Description of the Background Art

Supply chain systems often undergo several improvement efforts. These efforts are largely aimed at making informed decisions regarding various factors involved in a supply chain system. Conventional systems use simulation tools to analyze an already existing supply chain.

The outputs of these tools, presented in user-friendly formats such as graphs or charts, assist the management in making decisions concerning the supply chain. Hence, there are many supply chain management software applications that help in managing the day-to-day operations of a supply chain.

Although there are many supply chain management software applications that help in managing the day-to-day operations in a Supply Chain, these applications do not design the supply chain architecture by combining business strategies and analytical modeling in a well-defined process.

### SUMMARY OF THE EMBODIMENTS OF THE INVENTION

In one embodiment, the invention provides a method for designing a supply chain. The method comprises (i) identifying at least one business rule; (ii) identifying at least one product and customer characteristic for the supply chain; (iii) identifying at least one performance measure for quantifying the efficiency of the supply chain;(iv) recommending at least one supply chain, based on at least one identified business rule, the product and customer characteristic, and performance measure; (v) evaluating at least one of the identified performance measures of at least one of the recommended supply chains; (vi) evaluating the compliance with at least one identified business rule for at least one of the recommended and analyzed supply chain; (vii) collecting feedback from all related parties regarding at least one of the recommended and analyzed supply chain; (viii) optionally modifying (i.e., modifying none/zero or at least one of) the recommended supply chain based on at least one of the collected feedback, and the evaluations, wherein the modification is performed to generate a most appropriate supply chain; and (ix) communicating a supply chain strategy and architecture (i.e., the final or the most appropriate supply chain strategy and architecture) to all the related parties.

In another embodiment, the invention provides a system for designing a supply chain. The system comprises (i) means for identifying at least one business rule; (ii) means for identifying at least one product and/or customer characteristic; (iii) means for identifying at least one performance measure to quantify the efficiency of the supply chain;(iv) means for recommending at least one supply chain, based on at least one identified business rule, product and customer characteristic, and performance measure; (v) means for evaluating at least one of the identified performance measures of at least one of the recommended supply chains; (vi) means for evaluating compliance with at least one identified business rule of at least one of the recommended supply chains; (vii) means for collecting feedback from all related parties regarding at least one of the recommended supply chains; (viii) means for optionally modifying (i.e., modifying none/zero or at least one of) the recommended supply chains, based on at least one collected feedback and evaluation, wherein the modification is performed to generate the most appropriate supply chain; and (ix) means for communicating a supply chain strategy and architecture (i.e., the final or the most appropriate supply chain strategy and architecture) to all the related parties.

In another embodiment, the invention provides a system for designing a supply chain. The system comprises (i) a rule identifier for identifying at least one business rule (ii) a characteristic identifier for identifying at least one product and customer characteristic of the supply chain; (iii) a performance measure identifier for identifying at least one performance measure for quantifying the efficiency of the supply chain; (iv) a recommendation generator for recommending at least one supply chain, based on at least one identified business rule, product, customer characteristic and performance measure; (v) a performance measure evaluator for evaluating at least one of the identified performance measures of at least one of the recommended supply chains; (vi) a compliance evaluator for evaluating compliance with the identified business rule of at least one of the evaluated supply chains; (vii) a feedback collector for collecting feedback from all related parties regarding at least one of the evaluated supply chains; (viii) a strategy modifier for modifying if desired (e.g., modifying is optional and no modifying may be conducted) the recommended supply chains, based on at least one collected feedback and the evaluations, wherein the modification is performed to generate a most appropriate supply chain; and (ix) a communicator for communicating a supply chain strategy and architecture (i.e., the final or the most appropriate supply chain strategy and architecture) to all the related parties.

These provisions, together with various ancillary provisions and features, which will be apparent to artisans possessing skill in the art, as the following description proceeds, are attained by devices, assemblies, systems and methods of embodiments of the present invention. The various embodiments thereof being shown with reference to the accompanying drawings, by way of example only, wherein:

### BRIEF DESCRIPTION OF THE DRAWINGS

FIG. 1 is a schematic diagram illustrating an exemplary system environment for the operation of a method for designing a supply chain, in accordance with various embodiments of the invention.

FIG. 2 is a schematic diagram of a supply chain designer, in accordance with various embodiments of the invention.

FIG. 3 is a flowchart describing a method for designing a supply chain, in accordance with various embodiments of the invention.

FIG. 4 is a detailed flowchart describing a method for designing, evaluating and communicating supply chains, in accordance with various embodiments of the invention

### DETAILED DESCRIPTION OF THE EMBODIMENTS OF THE INVENTION

A supply chain comprises a chain of progression of material and/or information through a logistic process in an organization. The present invention provides a web-based, closed-loop process that designs, evaluates and communicates product-specific supply chains based on business rules and analytical modeling.

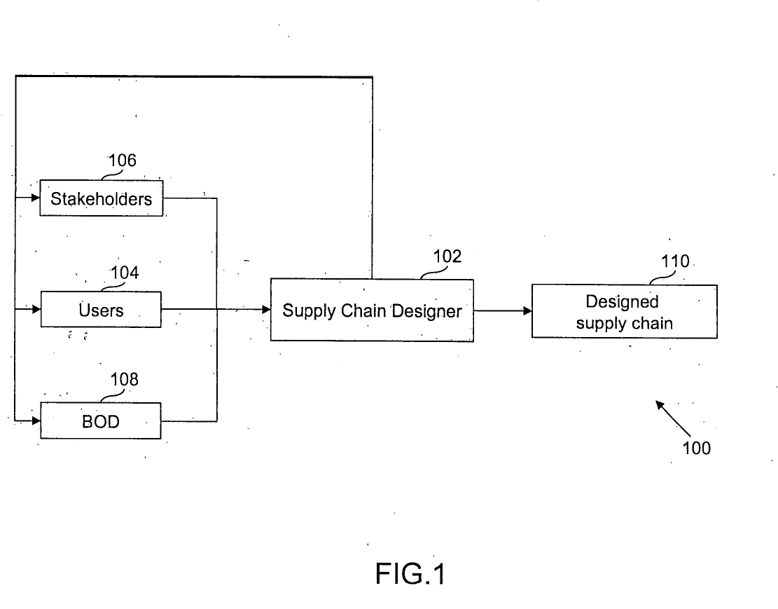

Referring now to FIG. 1, system 100 comprises a supply chain designer 102 that can design a supply chain 110, based on the inputs provided by a plurality of users 104 and the rules provided by stakeholders 106. The designed supply chain may be evaluated by a final decision maker. For illustrative purposes, the designed supply chain is evaluated by a Business Operations Director (BOD) 108. The process described in the invention is a closed loop process for designing a supply chain that aligns with the cross-functional strategies of the company and related parties. This alignment is achieved by combining product-specific attributes and cross-functional specifications. Supply chain designer 102 generates a supply chain based on the product-specific attributes, cross-functional specifications and analytical modeling. In an embodiment, further improvements to the generated supply chain, suggested by one or more users 104, stakeholders 106 and BOD 108, may also be incorporated to design a more efficient supply chain.

In various embodiments of the invention, supply chain designer 102 may be implemented as a software (e.g., as an application program, object, agent, downloadable servlet, etc., in whole or part). The components of system 100 may be communicated transitionally, or more persistently, from local or remote storage to memory (SRAM, cache memory, etc.) for execution; or another suitable mechanism can be utilized, and elements can be implemented in a compiled or interpretive form. Further, various components of system 100 such as users 104, stakeholders 106 and BODs 108, may be connected through a network. In various embodiments, the network may be a LAN, a WAN, a MAN, or the Internet. Input, -intermediate or resulting data, or functional elements can further reside transitionally or persistently in a storage media, cache or other volatile or non-volatile memory (e.g., storage device or memory), in accordance with a particular application.

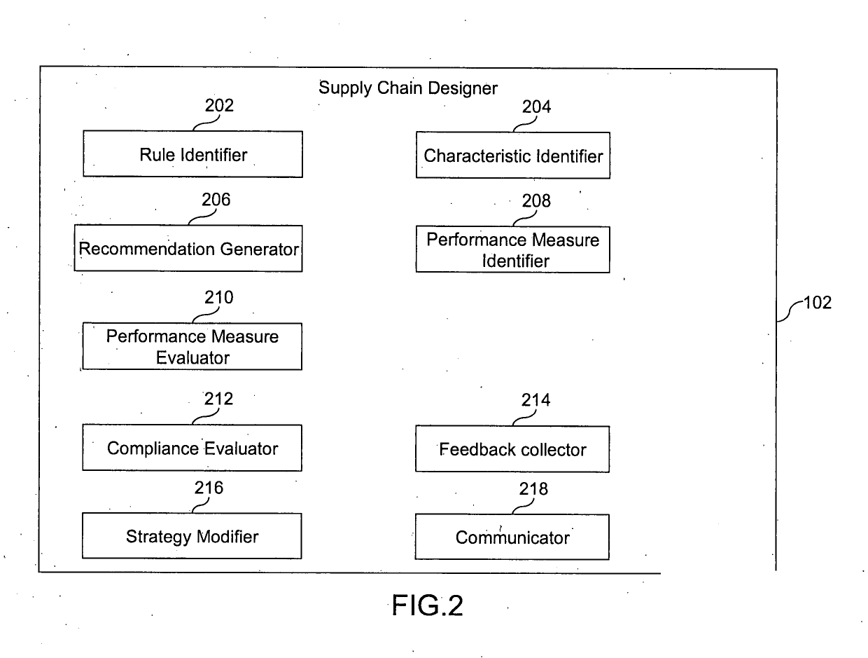

FIG. 2 is a schematic diagram of supply chain designer 102, in accordance with various embodiments of the invention. Supply chain designer 102 comprises a rule identifier 202, a characteristic identifier 204, a recommendation generator or identifier 206, a performance measure identifier 208, a performance measure evaluator 210, a strategy identifier 212, a compliance evaluator 214, a feedback collector 216, a strategy modifier 218, and a communicator 220. Rule identifier 202 identifies the business rules for a supply chain. In various embodiments, a group that owns the relationship with suppliers may make the business rules. In one embodiment of the invention, the suppliers may be contract manufacturers. In another embodiment of the invention, the business rules may be Global Transformation Management (GTM) business rules, which are based on Contract Manufacturer (CM) alignment. In another embodiment, the business rules are Supply Chain Strategy (SCS) business rules, based on the overall manufacturing strategy of the company. In another embodiment, the business rules are Tax and Customs business rules, based on the governmental customs regulations and trade agreements. In another embodiment, the business rules are Transportation business rules, based on the available transportation network. In another embodiment, the business rules are Logistics business rules, based on the available hub network.

Characteristic identifier 204 identifies the key characteristics of the product and the market. In various embodiments, the key characteristics are one or more of Intellectual Property considerations, complexity, configurability, forecasted volume, target lead time, customer location and specificities of the product design.

Performance measure identifier 208 identifies at least one performance measure. In an embodiment, the performance measure identifier selects the performance measure, based on a user selection. This selection can be made through a user interface such as a graphical user interface. The performance measure is a parameter of a supply chain used to quantify the efficiency of a supply chain. Therefore, performance measures are used to evaluate the performance of a supply chain. In various embodiments, the performance measures may be cost-related, time-related, or related to any other variable within the supply chain. For example, lead-time is a time-related performance measure that can be defined as the period of time between the initiation of the supply chain and its completion. Another example of a performance measure is product cost, which can be defined as the total cost incurred during the manufacture or procurement of a product in the supply chain.

Recommendation generator or identifier 206 recommends or identifies at least one supply chain, based on the identified business rules, performance measures, and product and customer characteristics. In an embodiment, recommendation generator or identifier 206 recommends or identifies at least one supply chain that satisfies the identified business rules, performance measures, and product and customer characteristics. In an embodiment, recommendation generator or identifier 206 selects at least one contract manufacturer from a predefined set of contract manufacturers that matches the identified business rules, and product and customer characteristics. In one embodiment, user 104 has the ability to challenge the recommendations made by recommendation generator or identifier 206.

Performance measure evaluator 210 evaluates the performance measures of the recommended supply chains. In an embodiment, each of the supply chains may be evaluated on the basis of at least one performance measure.

In various embodiments, compliance evaluator 212 evaluates the compliance of the recommended supply chain with the identified business rules. Feedback collector 214 collects feedback from any of the related parties, pertaining to the recommended supply chain. In various embodiments, the related parties may include one or more of stakeholders, users or BOD. The user (e.g., user 104) modifies the supply-chain strategy via the strategy modifier 216, based on either the collected feedback or the result of the evaluation. In various embodiments, the feedback collected from stakeholders 106 and BOD 108 is used to modify the recommended supply chain iteratively, which results in a most appropriate supply chain, complying with business rules. Strategy modifier 216 also updates the business rules, if required, based on the collected feedback. In various embodiments of the invention, strategy modifier 216 may be a user interface to receive modifications made by user 104. Communicator 218 communicates the recommended supply chain, the modified supply chain, and the responses of the concerned parties at predetermined stages.

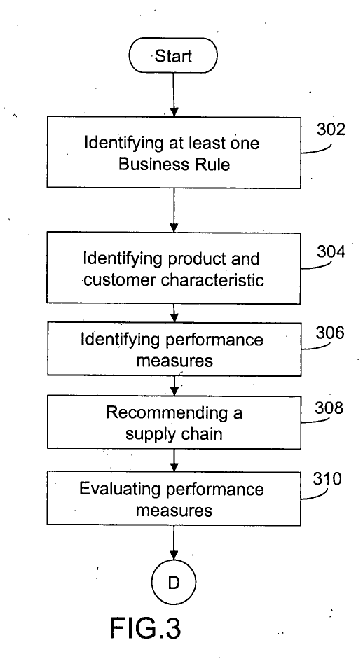

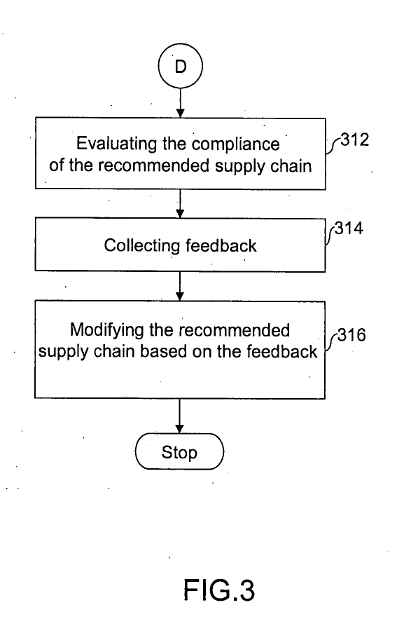

FIG. 3 is a flowchart describing a method for designing a supply chain, in accordance with various embodiments of the invention. At step 302, the business rules governing the designing of a required supply chain are identified. In various embodiments of the invention, the business rules are identified before designing the supply chain. Exemplary business rules have been described earlier in conjunction with FIG. 2. Next, at step 304, the characteristic of a product for which the supply chain is being designed is identified. In addition, the characteristics of the probable customers of the product are also identified. These characteristics may be Intellectual Property criticality, complexity, configurability, forecasted volume, target lead-time, location and specificities of the product design. At step 306, one or more performance measures are identified by performance measure identifier 208. A performance measure is a parameter of a supply chain that is used to quantify its efficiency. Therefore, performance measures are used to evaluate the performance of a supply chain.

Based on the identified characteristics, business rules and performance measures, recommendation generator or identifier 206 recommends at least one supply chain, as shown at step 308. In various embodiments, the performance measures may be cost-related, time-related, or related to any other important variable within the supply chain. At step 310, performance measure evaluator 210 evaluates the performance measures of the recommended supply chains.

At step 312, the compliance of the recommended (or the most appropriate) supply chain with the identified business rules is evaluated by compliance evaluator 212. Thereafter, feedback of the related parties, pertaining to the recommended supply chain, is collected and recorded for governance at step 314. In various embodiments, the related parties may be one or more stakeholders 106, BOD 108 and users 104. Then, at step 316, the user 104 modifies via the strategy modifier 216 the strategy and architecture of the most appropriate supply chain, on the basis of the collected feedback or the result of the evaluation. In various embodiments, the steps illustrated in FIG.3 are repeated, based on the various evaluation and the feedback from the related parties, thereby resulting in an improved supply chain that complies with the business rules. In various embodiments, the identified business rules may also be modified, based on the feedback of one or more concerned parties. In an embodiment, the concerned parties comprise stakeholders.

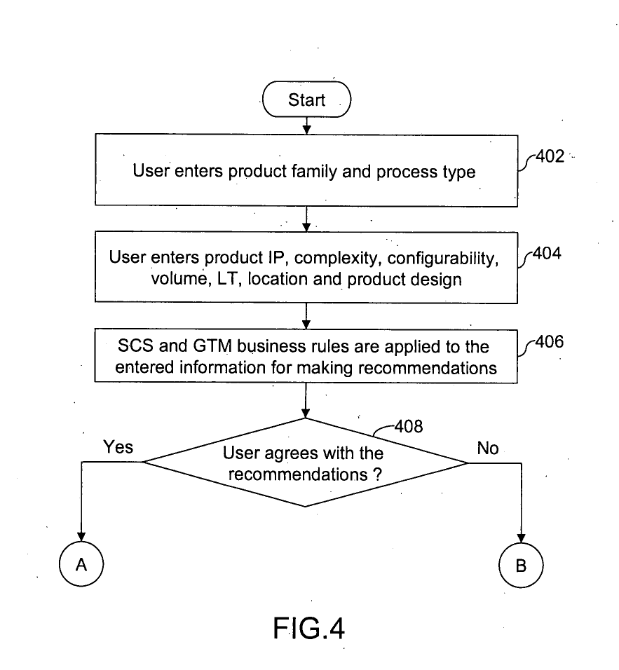

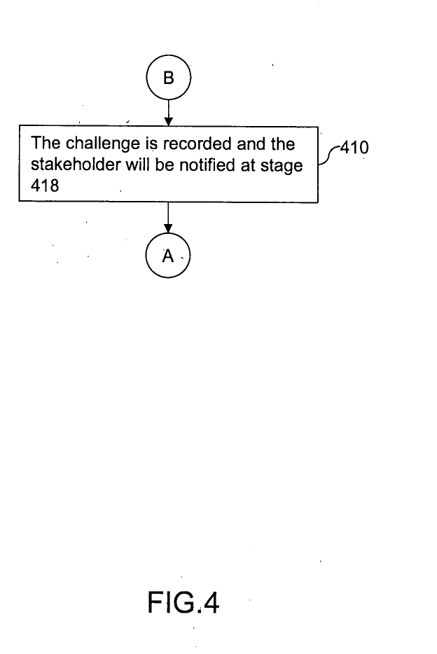

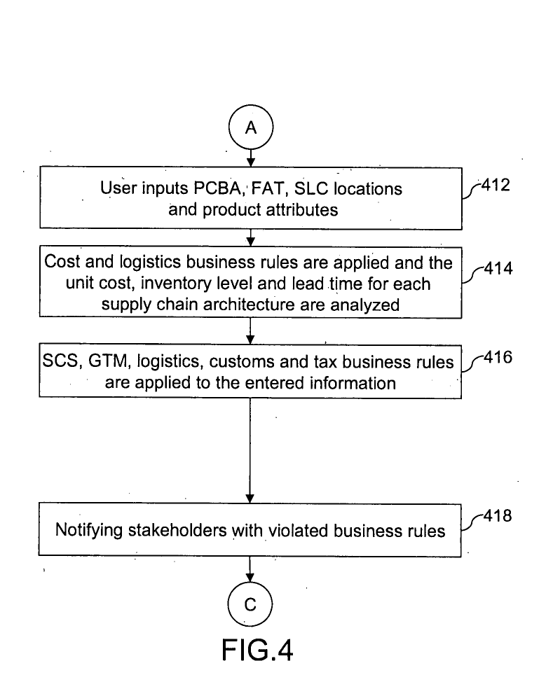

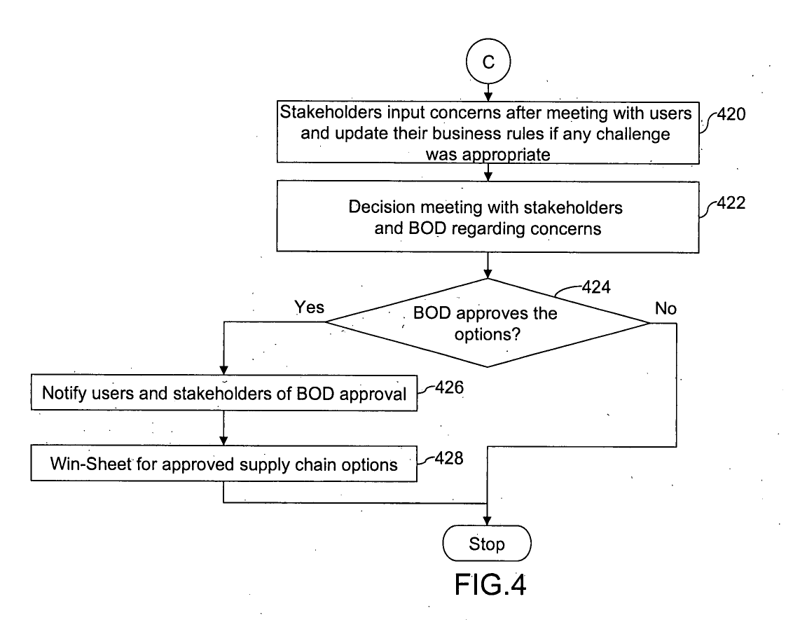

FIG. 4 is a detailed flowchart, describing a method for designing, evaluating and communicating supply chains, in accordance with various embodiments of the invention. At step 402, user 104 enters a product family and process type. At step 404, user 104 enters information such as Intellectual Property criticality, complexity, configurability, forecasted volume, target lead-time, customer location and specificities of the product design. In an embodiment, the inputs are entered into an input page, which can be a graphical or command line-user interface. Thereafter, at step 406, business rules are applied to the entered information, and one or more supply chains are recommended, based on the applied business rules and the information entered. In an embodiment, the recommendation is to manufacture a product regionally, based on volume characteristics, product design specificities and Supply Chain Strategy Business rules. In another embodiment, the recommendation is to outsource manufacturing of a product to a supplier based on product complexity, product design specificities and Global Transformation Management Business rules. Business rules may be Global Transformation Management business rules based on Contract Manufacturers alignment, and Supply Chain Strategy business rules based on the overall manufacturing strategy of the company. At step 408, user 104 evaluates the recommended supply chains and either accepts or rejects the recommendations or identifications made by recommendation generator or identifier 206. If user 104 rejects the recommendations or identifications, then user 104 may justify the reason and proceed with further analysis. Subsequently, at step 410 the system may record that user 104 challenged a business rule, and it will be subject to the approval of one or more concerned stakeholders. Then, at step 412 user 104 may enter specific product attributes and information specific to every supply chain that is to be evaluated and compared. In one embodiment, the product specific information is the weight and dimensions of the product. In another embodiment the Supply Chain information is the Printed Circuit Board Assembly site, the Final Assembly and Test site.

Next, the recommended supply chains are analyzed at step 414 by evaluating for each supply chain at least one identified performance measure and by comparing between the analyzed supply chains at least one common performance measure. To perform this step, cost and logistics business rules may be applied. In various embodiments; the unit cost, inventory level and customer lead-time are analyzed for each recommended supply chain. In another embodiment, risk expected impact is analyzed for each supply chain. Thereafter, at step 416, stakeholders 106 business rules are applied to the identified information. In an embodiment of the invention, stakeholders 106 include SCS, GTM, customs, tax and logistics and transportation. Communicator 218 notifies stakeholder 106 about any violated business rules, as shown at step 418. Thereafter, at step 420, stakeholders 106 review the analyzed supply chains and input their concerns regarding the recommended supply chains. The business rules may also be updated if the concerns are appropriate. At step 422, a decision meeting is scheduled with concerned stakeholders 106, user 104 and BOD 108 regarding the concerns raised by stakeholders 106. At step 424, BOD 108 approves or rejects the recommended supply chains. If the BOD rejects the recommended supply chains, the recommended supply chains are discarded. If the BOD approves the changes, communicator 218 notifies users 104 and stakeholders 106 regarding BOD approval, as shown at step 426. Thereafter, at step 428, a financial profit and loss (P&L) win-sheet is saved and recorded for approved supply chains.

Embodiments of the present invention have the advantage that a preferred supply chain for any given product may be designed such that it meets a company's strategy as well as customer requirements. Another advantage is that the system may be used at any time in the product life cycle like new product introduction, sustaining phase and end of life to design a new supply chain or re-design the current supply chain based on the changed product or customer attributes. Also the invention provides a process to measure and compare consistently the efficiency of a Supply chain design. Yet another advantage is that the invention creates transparency of requirements and objectives during the supply chain design process and promotes communication between the affected business units and the central stakeholders. Another advantage is that the invention is highly scaleable and flexible, allowing new strategies and stakeholders or changes to data and metrics without requiring process modifications.

Although the invention has been discussed with respect to specific embodiments thereof, these embodiments are merely illustrative, and not restrictive, of the invention. Although specific protocols have been used to describe embodiments, other embodiments can use other transmission protocols or standards. The present invention can operate between any two processes or entities including users, devices, functional systems, or combinations of hardware and software. Peer-to-peer networks and any other networks or systems where the roles of client and server are switched, change dynamically, or are not even present, are within the scope of the invention.

Any suitable programming language can be used to implement the routines of the present invention including C, C++, Java, assembly language, etc. Different programming techniques such as procedural or object oriented can be employed. The routines can execute on a single processing device or multiple processors. Although the steps, operations, or computations may be presented in a specific order, this order may be changed in different embodiments. In some embodiments, multiple steps shown sequentially in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein for embodiments of the present invention, numerous specific details are provided, such as examples of components and/or methods, to provide a thorough understanding of the embodiments of the present invention. One skilled in the relevant art will recognize, however, that an embodiment of the invention can be practiced without one or more of the specific details, or with other apparatus, systems, -assemblies, methods, components, materials, parts, and/or the like. In other instances, well-known structures, materials, or operations are not specifically shown or described in detail to avoid obscuring aspects of embodiments of the present invention.

In the description herein for embodiments of the present invention, a portion of the disclosure recited in the specification contains material, which is subject to copyright protection. Computer program source code, object code, instructions, text, or other functional information that is executable by a machine may be included in an appendix, tables, figures, or in other forms. The copyright owner has no objection to the facsimile reproduction of the specification as filed in the Patent and Trademark Office. Otherwise all copyright rights are reserved.

A ‘computer’ for purposes of embodiments of the present invention may include any processor-containing device, such as a mainframe computer, personal computer, laptop, notebook, microcomputer, server, personal data manager or ‘PIM’ (also referred to as a personal information manager), smart cellular or other phone, smart card, set-top box, or any of the like. A ‘computer program’ may include any suitable locally or remotely executable program or sequence of coded instructions, which are to be inserted into a computer, well known to those skilled in the art. Stated more specifically, a computer program includes an organized list of instructions that, when executed, causes the computer to behave in a predetermined manner. A computer program contains a list of ingredients (called variables) and a list of directions (called statements) that tell the computer what to do with the variables. The variables may represent numeric data, text, audio, or graphical images. If a computer is employed for synchronously presenting multiple video program ID streams, such as on a display screen of the computer, the computer would have suitable instructions (e.g., source code) for allowing a user to synchronously display multiple video program ID streams in accordance with the embodiments of the present invention. Similarly, if a computer is employed for presenting other media via a suitable directly/indirectly coupled input/output (I/O) device, the computer would have suitable instructions for allowing a user to input or output (e.g., present) program code and/or data information, respectively in accordance with the embodiments of the present invention.

A ‘computer readable medium’ for purposes of embodiments of the present invention may be any medium that can contain, store, communicate, propagate, or transport the computer program for use by or in connection with the instruction execution system apparatus, system, or device. The computer readable medium can be, by way of example only but not by limitation, an electronic, magnetic, optical, electromagnetic, infrared, or semiconductor system, apparatus, system, device, propagation medium, or computer memory. The computer readable medium may have suitable instructions for synchronously presenting multiple video program ID streams, such as on a display screen, or for providing for input or presenting in accordance with various embodiments of the present invention.

Reference throughout this specification to ‘one embodiment’, ‘an embodiment’, or ‘a specific embodiment’ means that a particular feature, structure, or characteristic described in connection with the embodiment is included in at least one embodiment of the present invention and not necessarily in all embodiments. Thus, respective appearances of the phrases ‘in one embodiment’, ‘in an embodiment’, or ‘in a specific embodiment’ in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as a part of the spirit and scope of the present invention.

Further, at least some of the components of an embodiment of the invention may be implemented by using a programmed general purpose digital computer, by using application-specific integrated circuits, programmable logic devices, or field-programmable gate arrays, or by using a network of interconnected components and circuits. Connections may be wired, wireless, by modem, and the like.

It will also be appreciated that one or more of the elements depicted in the drawings/figures can be implemented in a more separated or integrated manner, or even removed or rendered as inoperable in certain cases, as is useful in accordance with a particular application. It is also within the spirit and scope of the present invention to implement a program or code that can be stored in a machine-readable medium to allow a computer to perform any of the methods described above.

Additionally, any signal arrows in the drawings/figures should be considered only as exemplary, and not limiting, unless otherwise specifically noted. Furthermore, the term ‘or’ as used herein is generally intended to mean ‘and/or’, unless otherwise indicated. Combinations of components or steps will also be considered as being noted, where terminology is foreseen as rendering the ability to separate or combine is unclear.

As used in the description herein and throughout the claims that follow, ‘a’, ‘an’, and ‘the’ include plural references, unless the context clearly dictates otherwise. Also, as used in the description herein and throughout the claims that follow, the meaning of ‘in’ includes ‘in’ and ‘on’, unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Therefore, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A method for designing a supply chain, the method comprising:
identifying at least one business rule;
identifying at least one product and customer characteristic for the supply chain;
identifying at least one performance measure for quantifying efficiency of the supply chain;
recommending at least one supply chain based on the identified business rule, product and customer characteristic and performance measure;
evaluating at least one recommended supply chain based on at least one identified performance measure; and
evaluating the compliance with at least one identified business rule for at least one of the recommended supply chain.

2. The method of claim 1 additionally comprising:
collecting feedback from all related parties regarding at least one of the recommended supply chain;
modifying one or more of the recommended supply chain based on at least one of the collected feedback, and the evaluations, wherein the modification is performed to generate a final supply chain; and
communicating a final supply chain strategy and architecture to all related parties.

3. The method of claim 1 wherein the at least one performance measure comprise at least one of lead time, product cost, revenue, inventory and risk.

4. The method of claim 1 wherein the business rules define at least one of best practices and constraints within the supply chain.

5. The method of claim 1 wherein the business rules are developed on the basis of at least one of manufacturing strategy, government regulations, available transportation network, available shipping hub or CM Alignment.

6. The method of claim 2 wherein the related parties comprise stakeholders.

7. A system for designing a supply chain, the system comprising:
means for identifying at least one business rule;
means for identifying at least one product and customer characteristic for the supply chain;
means for identifying at least one performance measure for quantifying efficiency of the supply chain;
means for recommending at least one supply chain based on the identified business rule, product and customer characteristic and performance measure;
means for evaluating at least one of the identified performance measure of at least one of the recommended supply chain; and
means for evaluating the compliance with at least one identified business rule for at least one of the recommended supply chain.

8. The system of claim 7 additionally comprising:
means for collecting feedback from all related parties regarding at least one of the recommended supply chain;
means for modifying one or more of the recommended supply chain based on at least one of the collected feedback, and the evaluations, wherein the modification is performed to generate a final supply chain; and
means for communicating a final supply chain strategy and architecture to all related parties.

9. The system of claim 7, wherein the related parties comprise stakeholders.

10. The system of claim 7, wherein the means for identifying business rules take into account at least one of manufacturing strategy, government regulations, available transportation network, available shipping hub or CM alignment.

11. A system for designing a supply chain, the system comprising:
a rule identifier for identifying at least one business rule;
a characteristic identifier for identifying at least one product and customer characteristic for the supply chain;
a performance measure identifier for identifying at least one performance measure for quantifying the efficiency of the supply chain;
a recommendation generator for recommending at least one supply chain based on the identified business rule, product and customer characteristic;
a performance measure evaluator for evaluating at least one of the identified performance measure of at least one of the recommended supply chain; and
a compliance evaluator for evaluating the compliance with at least one of the identified business rules for at least one of the recommended supply chain.

12. The system of claim 11 additionally comprising:
a feedback collector for collecting feedback from all related parties regarding at least one of the recommended supply chain;
a strategy modifier for modifying one or more of the recommended supply chain based on at least one of the collected feedback, and the evaluations, wherein the modification is performed to generate a final supply chain; and
a communicator for communicating a final supply chain strategy and architecture to all related parties.

13. The system of claim 12, wherein the related parties comprise stakeholders.

14. The system of claim 12, wherein the rule identifier takes into account at least one of manufacturing strategy, government regulations, available transportation network, available shipping hub or CM alignment.

15. An apparatus for designing a supply chain, the apparatus comprising:
a computer;
a machine-readable medium including instructions executable by the computer comprising:
one or more instructions for identifying at least one business rule;
one or more instructions for identifying at least one product and customer characteristic for the supply chain;
one or more instructions for identifying at least one performance measure for quantifying efficiency of the supply chain;
one or more instructions for recommending at least one supply chain based on at least one of the identified business rules, product and customer characteristic and performance measure;
one or more instructions for evaluating at least one of the identified performance measure of at least one of the recommended supply chain; and
one or more instructions for evaluating the compliance with the identified business rule for at least one of the recommended supply chain.

16. The apparatus of claim 15 wherein said instructions additionally comprising:
one or more instructions for collecting feedback from all related parties regarding at least one of the recommended supply chain;
one or more instructions for modifying one or more of the recommended supply chain based on at least one of the collected feedback, and the evaluations, wherein the modification is performed to generate a final supply chain; and
one or more instructions for communicating a final supply chain strategy and architecture to all related parties.

17. A machine-readable medium including instructions executable by a computer comprising:
one or more instructions for identifying at least one business rule for a supply chain;
one or more instructions for identifying at least one product and customer characteristic for the supply chain;
one or more instructions for identifying at least one performance measure for quantifying efficiency of the supply chain;
one or more instructions for recommending at least one supply chain based on at least one identified business rule, product and customer characteristic and performance measure;
one or more instructions for evaluating at least one of the identified performance measure of at least one of the recommended supply chain; and
one or more instructions for evaluating the compliance with the identified business rule for at least one of the recommended supply chain.
